(19) United States
(12) Patent Application Publication
(10) Pub. No.: US 2020/0247663 A1
(43) Pub. Date: Aug. 6, 2020

(54) MONITORING AND REMINDING SYSTEM FOR WATER DISPENSER DEVICES

(71) Applicant: Kuang F Cheng, Taipei City (TW)

(72) Inventor: Kuang F Cheng, Taipei City (TW)

(21) Appl. No.: 16/856,063

(22) Filed: Apr. 23, 2020

Related U.S. Application Data
(63) Continuation of application No. 15/978,201, filed on May 14, 2018.

(51) Int. Cl. B67D 3/00; G01F 23/20

(52) U.S. Cl. CPC B67D 3/0032; F25D 31/002; G01F 23/20

(57) ABSTRACT

A monitoring and reminding system for water dispenser devices is provided, in that sensors are provided to detect the volume of the water buckets installed in the water dispenser device and the detecting results are transferred to a processing unit. Based on volume of water in the water bucket and update condition of the water bucket in the water dispenser device, volume of water consumed by a customer can be derived. Then relative reminding sentences are determine and provided to users. Therefore, supplement of water can be performed in advance and customers and managers can understand the whole operations of the system based on the data in the customer database and the operation results from the statistical unit. Furthermore such operation can be performed automatically so as to greatly promote convenience and efficiency of water supplement and message communication.

The invention is a continuation in part (CIP) of the U.S. patent application Ser. No. 15/978,201 invented and assigned to the inventor of the present invention, and thus the contents of the U.S. patent application Ser. No. 15/978,201 are incorporated into the present invention as a part of the specification.

### FIELD OF THE INVENTION

The present invention is related to monitor of water dispensers and in particular to a monitoring and reminding system for water dispenser devices.

### BACKGROUND OF THE INVENTION

Currently, many houses and offices use water dispensers to supply drinkable water, in that water buckets are installed in water dispensers. If water in the water bucket exhausts, the water bucket is taken down from the water dispenser and another one is installed therein. However, by this way to provide drinkable water, a customer cannot know how much water is drank, and how many water buckets have exhausted. Thus he or she does not know when to call the water provider to supply water buckets.

However, quantity of water drank is very important to human health and it gets more and more attentions to people. Furthermore the water suppliers also need to know conditions of water buckets stored in various customers so the suppliers could determine an effective way for distributing water buckets to customers. Conventional ways for resolving above mentioned problems are based on the orders from the customers. Suppliers are passive to know the status of the water supply condition, but this is inefficient to the suppliers. Further, customers do not know how much water to be drank and how many water buckets are left in the customers so that customers cannot have an effective way for managing water drank and the number of water buckets.

For currently electronic society, many different kinds of sensors are developed to detect different physics quantities and then these physics quantities are analyzed to get many useful results which are helpful to human life. Therefore the inventor of the present invention desires to combine current advanced electronic devices and technology with the conventional water dispensers to resolve above mentioned defects in dispense of water.

### SUMMARY OF THE INVENTION

Accordingly, the object of the present invention is to provide a monitoring and reminding system for water dispenser devices, wherein sensors are provided to detect the volume of the water buckets installed in the water dispenser device and the detection results are transferred to a processing unit. Based on volume of water in the water bucket and update condition of the water bucket in the water dispenser device, volume of water consumed by a customer can be derived. Then relative reminding sentences are determine and provided to users. Therefore, supplement of water can be performed in advance and customers and managers can understand the whole operations of the system based on the data in the customer database and the operation results from a statistical unit. Furthermore such operation can be performed automatically so as to greatly promote convenience and efficiency of water supplement and message communication.

To achieve above object, the present invention provides.

### BRIEF DESCRIPTION OF THE DRAWINGS

FIG. 1 is a schematic view showing the whole system of the present invention.

FIG. 2 is a schematic view showing that a water bucket is installed to a water dispenser device.

FIG. 3 is a block diagram about the operation structure of the present invention.

FIG. 4 is a function block diagram showing the element arrangement according to the present invention, wherein the processing unit is installed in the website end electronic device.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

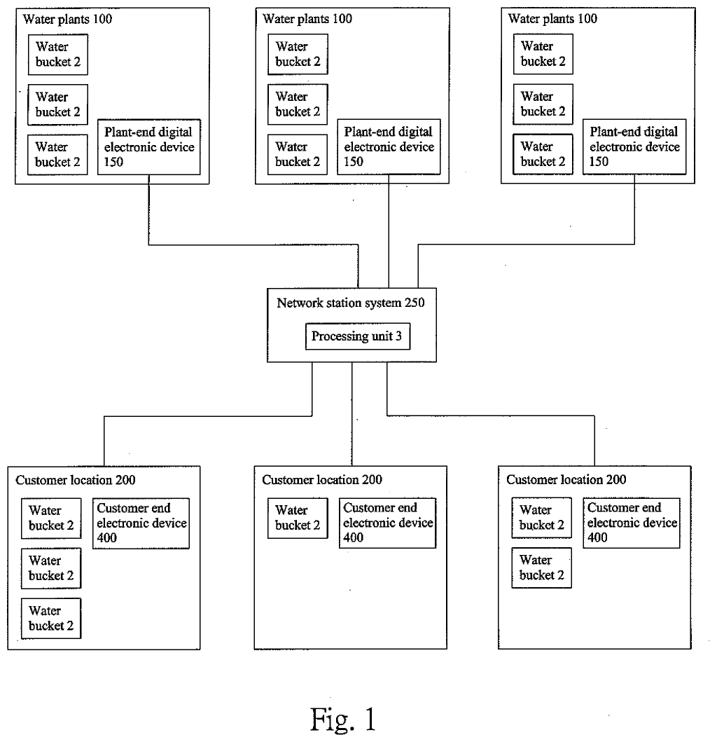

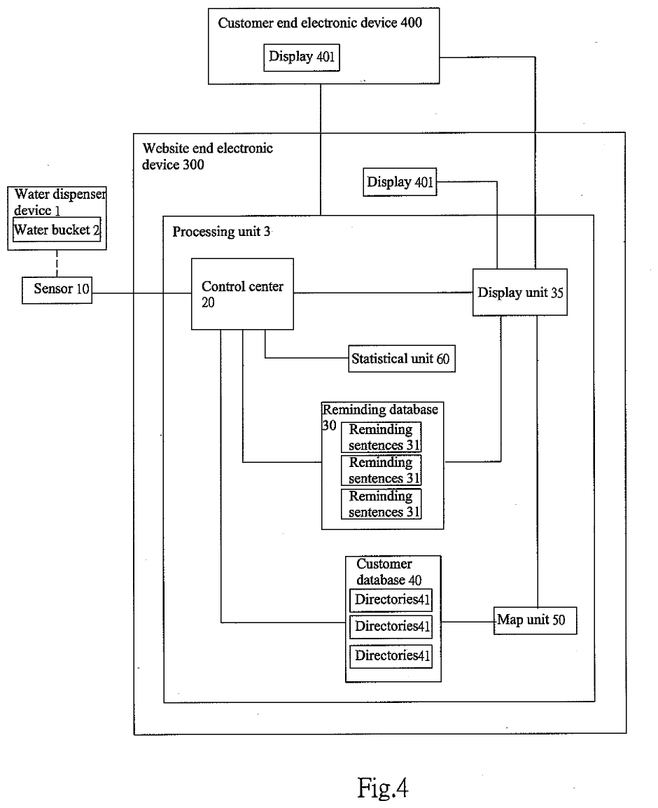

With reference to FIGS. 1 to 4, the structure of the present invention includes the following elements.

With reference to FIG. 1, the multi-station water supply system according to the present invention is illustrated. FIG. 1 shows the practical arrangement about the hardware of the present invention. In the drawing, it is illustrated in the system of the present invention, there are a plurality of water plants 100 which serve to make water with desired specifications and distribute the water into a plurality of water buckets 2. Similarly, there are a plurality of customer locations 200 each of which has at least one water dispenser device 1 and at least one water bucket 2. When the amount of the water buckets 2 in the customer location 2 are insufficient, the water plants 100 will supply water buckets 2 to the customer location 200. In the present invention, the quantity of each water buckets 2 may be limited to be greater than 2 gallons.

With reference to FIG. 1, the present invention includes a plurality of plant-end digital electronic devices 150 which are arranged in respective water plants 100.

With reference to FIG. 1, it is illustrated that the present invention further includes a network station system 250. The network station system 250 serves to transfer information about the number of the water bucket 2 in the customer locations 200 to the plant-end digital electronic devices 150 so that the water plants 100 can supply water buckets 2 to the customer locations 200 as the number of water buckets 2 is insufficient.

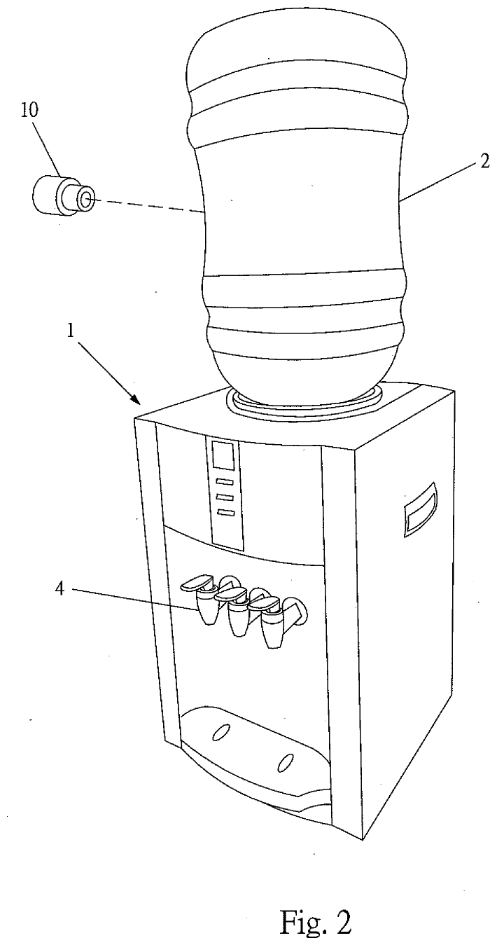

In the present invention, as shown in FIG. 2, the water dispenser device 1 serves to be installed with a water bucket 2 for providing drinkable water to people. However, drinking water supplied to the water dispenser device 1 is not supplied through water tubes from external water source, but it is just from the water bucket 2, as illustrated in FIG. 2. The water dispenser device 1 includes a water outlet 4 for outputting water in the water bucket 2 to the drinker. If necessary, the water can be heated or cooled.

Each water dispenser device 1 includes a sensor 10 which is installed in or near the water dispenser device 1 for detecting volume of water in the water bucket 2 and outputting data about the volume of water in the water bucket 2. Preferably, transmission of data by the sensor 10 is preformed wirelessly or wired, such as by Wi-Fi, NFC (near field communication) or communication networks, or other suitable ways.

Furthermore an intellectual determination can be used, for example, if the volumes of water in a previous water bucket 2 and in a new updated water bucket 2 are almost equal, the sensor 10 determines that the water bucket 2 is not updated. Or a label can be adhered on the water bucket 2 for identification and the sensor 10 detects the label to determine whether the water bucket 2 is updated. All these technologies are known in the prior arts and thus they will not be described herein, however, all these technologies are within the scope of the present invention.

The ways of the sensor 10 to detect the volume of water are, for example, to detect the weight of the water bucket 2, or to detect the water level by using laser. However, all of the ways to determine the volume of water are within the scopes of the present invention.

The sensor 10 shown in FIG. 2 is only as an example, but it is not used to confine the scope of the present invention.

The network station system 250 further includes a processing unit 3. The processing unit 3 includes the following elements.

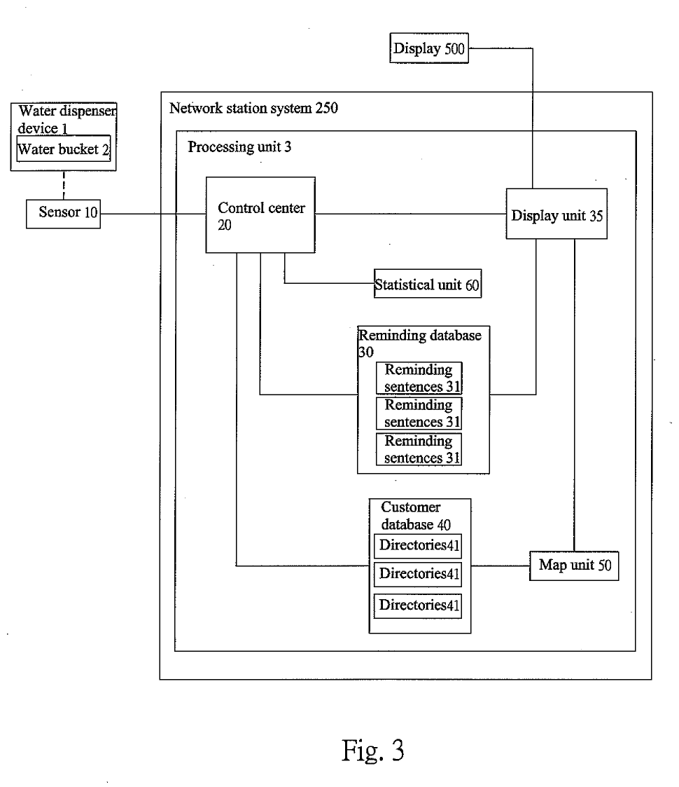

A control center 20 is signally connected to the sensor 10, as illustrated in FIG. 3. The control center 20 serves to receive the data about the volume of the water in the water bucket 2. The data is useful for update of the water bucket 2.

The control center 20 may assure whether the water bucket 2 is updated by a new one by using logic operation, such as the volume of water in the water bucket is abruptly increase to a full level, or to detect whether the water bucket 2 is taken out from the water dispenser device 1 and a new one is put on the water dispenser device 1.

The control center 20 calculates surplus water in the water bucket 2 for each customer. For example, if originally 10 water buckets 2 are stored in the customer location 200 and the sensor 10 has detected that water in two water buckets 2 are exhausted. Then the control center 20 knows that the customer location 200 still has 8 water buckets 2 which are full of water. The control center 20 is realized by, for example, an electronic processor.

A reminding database 30 is connected to the control center 30. The reminding database 30 stores different reminding sentences 31. Each reminding sentences 31 is correspondent to a message derived from the control center 20.

The reminding sentences 31 in the remind database 30 have different contents. For example, when the number of the water buckets 2 is insufficient, the reminding sentence is to inform the user to supplement water buckets 2 to the customer; or if the consumption of water is too much, the reminding sentence is to remind the customer to check if the water bucket 2 has drainage.

A display unit 35 is connected to the control center 20 and a display 500. According to the messages output from the control center 20, relative reminding sentences 31 are outputted to the display 500.

The processing unit 3 further includes a customer database 40 which is connected to the control center 20. The customer database 40 includes a plurality of directories 41. Each customer has a dedicated directory 41 which records the order records about the customer and relative messages transferred from the control center 20.

The processing unit 3 further comprising a map unit 50 which is connected to the customer database 40 and the display unit 35 for generating relations between the map and the customer, such as the position of the customer location 200, or the storage of the water buckets 2 of the customer location 200, and other messages in the directories 41 of the customer database 40. Furthermore by clicking a point on the map through the display, the map can display the information of the customer location 200 near this clicking points, such as storage of the water buckets 2.

The processing unit 3 further includes a statistical unit 60 which is connected to the control center 20 for calculating statistical data about the present invention. The statistical unit 60 is set with various statistical operations and the statistical calculation results can be presented through the display unit 35.

For example, the numbers of the water buckets 2 in the customer ends, or consumptions of the waters for each customer location 200. can be derived from the statistical unit 60 by getting data in the customer databases 40. The managers of the system may understand the whole distributions about these items and thus understand the business conditions of their customers.

When surplus water buckets 2 are lower than a predetermined number, the control center 20 will inform the customer to supplement more water buckets 2; or when the surplus water buckets 2 are lower than a predetermined number, the control center 20 will inform the manager to supplement water buckets 2 to the customer automatically. Furthermore the control center 20 can determine the timings for supplements of water buckets 2 and the dispensing paths for supplements of water buckets 2 according to the data in the customer database 40.

There are many different ways which can arrangements elements for performing functions of the present invention, one way is shown in FIG. 5, the processing unit 3 is installed in at least one website end electronic device 300. A user can enter into the website end electronic device 300 to further enter into the processing unit 3. The display 500 connected to the display unit 35 may be a display 401 in the customer end electronic device 400 or a display 301 in the website end electronic device 300. In the present invention, the control center 20, the reminding database 30, the display unit 35, the customer database 40, the map unit 50, and the statistical unit 60 of the processing unit 3 may be arranged in different position based on practical usages. The website end electronic device 300 and the customer end electronic device 400 may be one of a handset, a computer, a tablet computer, a PDA, a server, etc.

The website end electronic device 300 may be a cloud server and thus the processing unit 3 is arranged in the cloud server, and thus a customer or a manager may enter into the processing unit 3 through the APP for processing necessary operations.

Advantages of the present invention are that sensors are provided to detect the volume of the water buckets 2 installed in the water dispenser device 1 and the detecting results are transferred to a processing unit 3. Based on the volume of water in the water bucket 2 and update condition of the water bucket 2 in the water dispenser device 1, volume of water consumed by a customer can be derived. Then relative reminding sentences 31 are determine and provided to users. Therefore, supplement of water can be performed in advance, and customers and managers can understand the whole operations of the system based on the data in the customer database 40 and the operation results from the statistical unit. Furthermore such operation can be performed automatically so as to greatly promote convenience and efficiency of water supplement and message communication.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A monitoring and reminding system for water dispenser devices; the system being used to a water dispenser device for installing with a water bucket for providing drinkable water to people; wherein drinkable water supplied to the water dispenser device is not through water tubes; the water dispenser device including a water outlet for outputting water of the water bucket to drinkers; the system comprising:
a sensor installed in the water dispenser device or near the water dispenser device for detecting a volume of water in the water bucket and outputting data about detecting results;
a processing unit including:
a control center connected to the sensor, the control center receiving data transmitted from the sensor; the control center calculating surplus water in the water bucket for each customer; the control center generating messages based on the data transmitted from the sensors;
a reminding database connected to the control center; the reminding database storing different reminding sentences; each reminding sentence being correspondent to a message generated in the control center; and
a display unit connected to the control center and a display; according to the messages output from the control center, the display unit causing relative reminding sentences being outputted to the display.

2. The monitoring and reminding system for water dispenser devices as claimed in claim 1, wherein the processing unit further includes a customer database which is connected to the control center; the customer database includes a plurality of directories; each customer has a dedicated directory which records the order records about the customer and relative messages transferred from the control center.

3. The monitoring and reminding system for water dispenser devices as claimed in claim 1, wherein the processing unit further comprises a map unit which is connected to the customer database and the display unit for generating relations between the map and the customer, the relations including positions of the customers in the map, or number of the water buckets of each customer, and other messages in the directories of the customer database.

4. The monitoring and reminding system for water dispenser devices as claimed in claim 1, wherein the processing unit further includes a statistical unit which is connected to the control center for calculating statistical data.

5. The monitoring and reminding system for water dispenser devices as claimed in claim 1, wherein when a number of surplus water buckets of a customer is lower than a predetermined number, the control center informs the customer to supply more water buckets; or the control center informs a manager to supplement water buckets to the customer automatically.

6. The monitoring and reminding system for water dispenser devices as claimed in claim 1, wherein the control center determines the timings for supplements of water buckets and the paths for supplements of water buckets according to data in the customer database.

7. The monitoring and reminding system for water dispenser devices as claimed in claim 1, wherein the processing unit is realized by an APP which is installed in a customer end electronic device.

8. The monitoring and reminding system for water dispenser devices as claimed in claim 1, wherein the processing unit is installed in at least one website end electronic device; a user can enter into the website end electronic device to further enter into the processing unit.

9. The monitoring and reminding system for water dispenser devices as claimed in claim 1, wherein the display connected to the display unit is a display in a customer end electronic device or a display in the website end electronic device.

10. The monitoring and reminding system for water dispenser devices as claimed in claim 1, wherein the reminding sentences in the remind database include a reminding sentence to inform a customer to order more water buckets and a reminding sentence to remind the customer to check if the water bucket has drainage.

11. The monitoring and reminding system for water dispenser devices as claimed in claim 1, wherein the sensor transmits data wirelessly.

12. The monitoring and reminding system for water dispenser devices as claimed in claim 1, wherein by using logic operation, when a volume of water is abruptly increase to a full level, the control center determines that a new water bucket is updated.

13. The monitoring and reminding system for water dispenser devices as claimed in claim 1, wherein the ways of the sensor to detect the volume of water are to detect a weight of the water bucket, or to detect a water level of the water bucket by using laser.

14. The monitoring and reminding system for water dispenser devices as claimed in claim 1, wherein the statistical unit is set with various statistical operations through the processing unit and statistical calculation results is presented through the display unit; the statistical unit determines the numbers of the water buckets in the customer ends, and consumptions of the waters for each customer by using data in the customer databases.
